(19) United States
(12) Patent Application Publication
(10) Pub. No.: US 2009/0199179 A1
(43) Pub. Date: Aug. 6, 2009

(54) System and method for terminating workflow instances in a workflow application

(75) Inventors: Christopher M. Morris, Olathe, KS (US); Michael A. DuRee, Independence, MO (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(73) Assignee: Embarq Holdings Company LLC, Overland Park, KS (US)

(21) Appl. No.: 12/012,189

(22) Filed: Jan. 31, 2008

(51) Int. Cl. G06F 9/46; G06F 13/00

(52) U.S. Cl. 718/100; 710/100

(57) ABSTRACT

The illustrative embodiments described herein provide a method, apparatus, and computer program product for terminating workflow instances in a workflow application. In one embodiment, the process receives a set of identifiers. The process identifies a set of workflow instance identifiers associated with the set of identifiers. The process terminates a set of workflow instances identified by the set of workflow instance identifiers.

### BACKGROUND

Workflows may be used by organizations, individuals, and other entities to achieve a wide range of objectives. A workflow is a set of activities that are organized to achieve one or more objectives. Each of the set of activities may be performed by one or more actors. Examples of actors in a workflow include human beings, software applications, machinery, organizational departments, and any other entity capable of performing an activity or executing a process. One early example of a workflow includes the assembly line, in which a linear series of workers each perform a task on a piece of equipment in order to achieve a final product, such as an automobile. Today, workflows are often used to process data. For example, data in a modern workflow maybe manipulated, authenticated, or transmitted by one or more actors using a pre-defined flow of interconnected steps in order to achieve an intended goal of the workflow.

Workflows may also be used by a department within an organization to render services to individuals or other departments within the organization, as well as customers and clients of the organization to which the department belongs. For example, companies and other large organizations generally have employees and departments that operate as internal service providers that handle certain operations to provide services to other departments within an organization. With the proliferation of computer networks at companies, information technology (IT), information services (IS), and other departments are responsible for handling questions, problems, training, equipment change requests, a change in production, business-related activities, personnel issues, and issues of employees needing assistance with operating various data processing equipment within the organization, such as personal computers, printers, fax machines, copiers, personal digital assistants, and telephones. To notify the IT department of a problem or change request for a piece of equipment, an employee may call, e-mail, or otherwise notify the IT department to give notice of the issue or provide a general description of the problem. Although this example illustrates an IT department managing various issues for intra-organizational individuals and departments, such issues may also be managed by a servicing department for outside clients and customers, such as clients and customers that utilize a computer network and data processing equipment.

A set of activities are typically associated with the issue being reported to the IT department. For example, for a request from an employee to service the employee's personal computer, a set of tasks or processes may need to be performed, such as notifying a particular department via e-mail or requesting supervisory approval for the service to the employee's personal computer. In order to facilitate the execution of these activities, a ticket associated with the issue may be generated or opened. Upon generating or opening the ticket, one or more workflow instances associated with the ticket may be opened whose objective is to perform the set of activities. Returning to the example above, upon receiving a request from an employee to service the employee's personal computer, a ticket and an associated workflow instance may be opened in which the first activities include sending an e-mail to a supervisor in the IT department to request approval. Thus, workflows can automate a set of activities that are associated with the ticket that is generated or opened as a result of a request or other issue originating from an individual, department, or organization, thereby saving the time and labor associated with the manual execution of these activities.

In large organizations or other entities that address a large number of issues using workflows, the workflow application used by the organization or entity may need to have a large number of workflow instances that may be opened at the same time. For example, in the application Workflow from CA®, Inc. (hereinafter CA® Workflow), which was founded as Computer Associates International™, Inc., a large number of workflow instances may be accessible through the Integrated Design Environment component of the application. However, when an issue associated with a workflow instance has been resolved or the workflow instance is not otherwise needed, the workflow instance may need to be terminated.

Current methods for terminating a workflow instance in a workflow application may require a user to search through multiple executing workflow instances to find the workflow instances to be terminated. In the case of an organization with thousands or tens of thousands of employees, there may be thousands of workflow instances executing at any given time. A user who is using CA® Workflow must manually and visually search through a large number of executing workflow instances using the Integrated Design Environment in order to find the workflow instance to be terminated. However, the process of searching for the workflow instance to be terminated, such as via the Integrated Design Environment, is a time-consuming and tedious process. This process can take even longer depending on the number of workflow instances executing in the workflow application.

Current methods for terminating workflow instances also require the ticket associated with the workflow instance to be terminated separately. For example, in CA® Workflow, a ticket associated with a workflow instance may remain open upon terminating the workflow instance. The ticket associated with the workflow instance must be terminated separately using a separate application, such as Unicenter® Service Desk. However, searching for the ticket in Unicenter® Service Desk is a time-consuming and tedious process that adds to the already wasted time of searching for the workflow instance to be terminated in the workflow application.

### SUMMARY

To alleviate the existing problems with terminating workflow instances in a workflow application, as well as eliminate the need to separately terminate each ticket associated with a terminated workflow instance via a separate application, the illustrative embodiments described herein are directed to a data processing system and, in particular, to a method and system for terminating workflow instances. More particularly, the illustrative embodiments are directed to a method, system, and computer-usable program code for terminating workflow instances in a workflow application, such as the Workflow application from CA®, Inc. In one illustrative embodiment, the process receives a set of identifiers. The process identifies a set of workflow instance identifiers associated with the set of identifiers. The process terminates a set of workflow instances identified by the set of workflow instance identifiers. In terminating the set of workflow instances, a search function may be utilized to identify the set of workflow instances with the set of workflow instance identifiers, respectively.

In one embodiment, receiving the set of identifiers includes receiving a set of ticket numbers associated with a set of tickets. In another embodiment, receiving the set of identifiers includes receiving the set of workflow instance identifiers. In these embodiments, receiving the set of ticket numbers and receiving the set of workflow instance identifiers may include receiving a text file including the set of ticket numbers or the set of workflow instance identifiers, respectively. The one or more workflow instances identified by either the set of ticket numbers or the set of workflow instance identifiers may then each be terminated in a batch process. In another embodiment, in response to terminating the set of workflow instances, the process may also terminate the set of tickets associated with the set of workflow instances using a service desk application.

### BRIEF DESCRIPTION OF THE DRAWINGS

Illustrative embodiments of the present invention are described in detail below with reference to the attached drawing figures, which are incorporated by reference herein and wherein:

FIG. 1 is a pictorial representation of a network data processing system in which the illustrative embodiments maybe implemented;

FIG. 2 is a block diagram of a data processing system in which the illustrative embodiments maybe implemented;

FIG. 3 is a block diagram of a ticket servicing system in which the illustrative embodiments maybe implemented;

FIG. 4 is a diagram of a workflow with which the illustrative embodiments may be implemented;

FIG. 5 is a diagram of a system for terminating workflow instances in a workflow application in accordance with an illustrative embodiment;

FIG. 6 is a graphical representation of a mass workflow terminate tool for terminating workflow instances in a workflow application in accordance with an illustrative embodiment;

FIG. 7 is a graphical representation of a text file containing identifiers for terminating workflow instances in a workflow application in accordance with an illustrative embodiment;

FIG. 8 is a flowchart illustrating a process for terminating workflow instances in a workflow application in accordance with an illustrative embodiment;

FIG. 9 is a flowchart illustrating a process for terminating workflow instances in a workflow application in accordance with an illustrative embodiment.

### DETAILED DESCRIPTION OF THE DRAWINGS

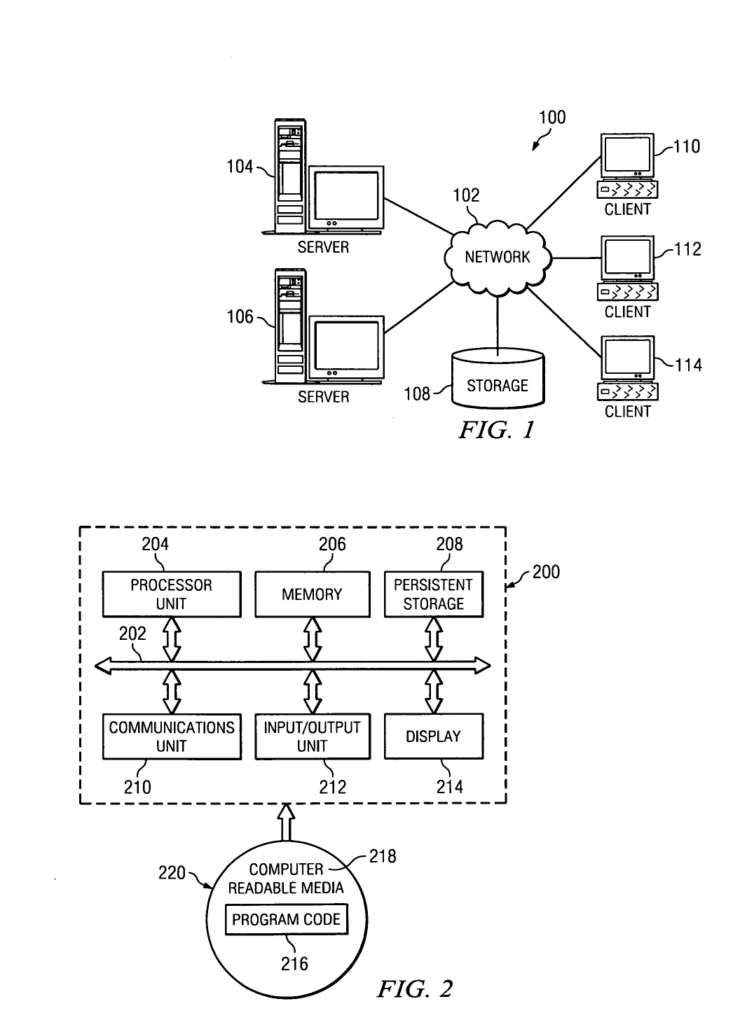

With reference now to the figures and in particular with reference to FIGS. 1 and 2, exemplary diagrams of data processing environments are provided in which illustrative embodiments may be implemented. It should be appreciated that FIGS. 1 and 2 are only exemplary and are not intended to assert or imply any limitation with regard to the environments in which different embodiments may be implemented. Many modifications to the depicted environments maybe made.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. Clients 110, 112, and 114 may be, for example, personal computers or network computers. In the depicted example, server 104 provides data, such as boot files, operating system images, and applications to clients 110, 112, and 114. Servers 104 and 106 may receive queries, such as service requests, from any of clients 110, 112, and 114 via network 102. Anyone of clients 110, 112, and 114 may also receive queries from other clients in clients 110, 112, and 114. Upon receiving such queries from clients 110, 112, and 114, a ticket servicing system on servers 104 and 106 that includes a service desk application, such as Unicenter® Service Desk, may then be used to generate or open a ticket associated with the query from clients 110, 112, and 114. A workflow application, such CA® Workflow, on servers 104 and 106 may then initiate one or more workflow instances that address the query from clients 110, 112, and 114. The workflow application and service desk application may also be located on any of clients 110, 112, and 114. Servers 104 and 106 may also contain web services, such as Unicenter® web services or CA® Workflow web services, which are accessible to other servers and clients 110, 112, and 114, and which facilitate the termination of workflow instances in the workflow applications contained on anyone of servers 104 and 106.

Clients 110, 112, and 114 are clients to server 104 in this example. Network data processing system 100 may include additional servers, clients, and other devices not shown. In one example, clients 110, 112, and 114 are data processing systems that are used by a respective customer, organization, department, employee, or other entity. In this example, each respective customer, organization, department, employee, or other entity may submit queries pertaining to any issue, including the servicing of clients 110, 112, and 114, to servers 104 and 106, another one of clients 110, 112, and 114, or any other data processing system that has a ticket servicing system. One or more of servers 104 and 106 and clients 110, 112, and 114 may also be part of an IT or IS department that services issues pertaining to each respective customer, organization, department, employee, or other entity. Storage 108 may contain data relating to the tickets and workflow instances associated with these issues.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

With reference now to FIG. 2, a block diagram of data processing system 200 is shown in which illustrative embodiments may be implemented. Data processing system 200 is an example of a computer, such as server 104 or client 110 in FIG. 1, in which computer-usable program code or instructions implementing the processes may be located for the illustrative embodiments. In this illustrative example, data processing system 200 includes communications fabric 202, which provides communications between processor unit 204, memory 206, persistent storage 208, communications unit 210, input/output (/O) unit 212, and display 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 maybe a symmetric multi-processor system containing multiple processors of the same type.

Memory 206, in these examples, may be, for example, a random access memory or any other suitable volatile or non-volatile storage device. Persistent storage 208 may take various forms depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive maybe used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard and mouse. Further, input/output unit 212 may send output to a printer. Display 214 provides a mechanism to display information to a user.

Instructions for the operating system and applications or programs are located on persistent storage 208. These instructions may be loaded into memory 206 for execution by processor unit 204. The processes of the different embodiments may be performed by processor unit 204 using computer-implemented instructions, which may be located in a memory, such as memory 206. These instructions are referred to as program code, computer-usable program code, or computer-readable program code that may be read and executed by a processor in processor unit 204. The program code in the different embodiments may be embodied on different physical or tangible computer-readable media, such as memory 206 or persistent storage 208.

Program code 216 is located in a functional form on computer-readable media 218 and may be loaded onto or transferred to data processing system 200 for execution by processor unit 204. Program code 216 and computer-readable media 218 form computer program product 220 in these examples. In one embodiment, computer program product 220 is a computer program product for terminating workflow instances in a workflow application, such as CA® Workflow.

In one example, computer-readable media 218 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer-readable media 218 also may take the form of a persistent storage, such as a hard drive or a flash memory that is connected to data processing system 200. The tangible form of computer-readable media 218 is also referred to as computer recordable storage media.

Alternatively, program code 216 may be transferred to data processing system 200 from computer-readable media 218 through a communications link to communications unit 210 and/or through a connection to input/output unit 212. The communications link and/or the connection may be physical or wireless in the illustrative examples. The computer-readable media also may take the form of non-tangible media, such as communications links or wireless transmissions containing the program code.

The different components illustrated for data processing system 200 are not meant to provide architectural limitations to the manner m which different embodiments may be implemented. The different illustrative embodiments may be implemented in a data processing system including components in addition to or in place of those illustrated for data processing system 200. Other components shown in FIG. 2 can be varied from the illustrative examples shown. As one example, a storage device in data processing system 200 is any hardware apparatus that may store data. Memory 206, persistent storage 208, and computer-readable media 218 are examples of storage devices in a tangible form.

In another example, a bus system maybe used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache such as found in an interface and memory controller hub that maybe present in communications fabric 202.

The illustrative embodiments described herein provide a computer-implemented method, apparatus, and computer program product for terminating workflow instances in a workflow application. In one embodiment, the workflow application is CA® Workflow. A program is one or more executable computer programming statements, such as program code 216 in FIG. 2.

The process may receive a set of identifiers. The set of identifiers includes one or more identifiers. The process may identify a set of workflow instance identifiers associated with the set of identifiers. The set of workflow instance identifiers includes one or more workflow instance identifiers. A workflow instance identifier is any identifier that identifies a workflow instance. For example, a workflow instance identifier may be one or more numbers, letters, characters, or any combination thereof.

In one embodiment, receiving the set of identifiers further includes receiving the set of workflow instance identifiers. In this embodiment, receiving the set of workflow instance identifiers may also include receiving a text file including the set of workflow instance identifiers. Alternatively, the set of workflow identifiers may be received via a graphical user interface (hereinafter “GUI”) using text entry boxes, selectable lists, search interfaces, or any other GUI interfaces.

In another embodiment, receiving the set of identifiers further includes receiving a set of ticket numbers associated with a set of tickets. The set of ticket numbers includes one or more ticket numbers. The set of tickets includes one or more tickets. A ticket is a file that is generated, opened, or otherwise associated with any query for which a workflow may be employed. For example, a ticket may be a Unicenter® Service Desk ticket. Unicenter® Service Desk is an application from CA®, Inc. that manages tickets. A ticket number is a number that identifies a ticket. However, a ticket may also be identified using one or more letters, characters, numbers, or any combination thereof. In another embodiment, receiving the set of ticket numbers further includes receiving a text file including the set of ticket numbers. Alternatively, a GUI may be utilized to receive the set of ticket identifiers. The set of ticket numbers may also be included in other types of files capable of including at least one ticket number.

Also, in this embodiment, identifying the set of workflow instance identifiers associated with the set of identifiers may include retrieving the set of workflow instance identifiers associated with the set of tickets from a service desk application, such as Unicenter® Service Desk, using a service desk web service. A service desk web service is any web service that is accessible from or otherwise associated with a service desk application, such as Unicenter® Service Desk However, the set of workflow instance identifiers may be retrieved using any web service. The web service may be accessible over a network, such as network 102 in FIG. 1.

In one example, retrieving the set of workflow instance identifiers associated with the set of tickets from the service desk web service may include accessing a database associated with the service desk web service. In this example, the process may also identify a set of records in the database that include the set of ticket numbers. A set of records is one or more records. A record is any data in a database. Also, in this example, the process may retrieve the set of workflow instance identifiers from the set of records.

In one embodiment, the process terminates a set of workflow instances identified by the set of workflow instance identifiers. The set of workflow instances includes one or more workflow instances. A workflow instance is an executing workflow in a workflow application, such as CA® Workflow.

In one embodiment, terminating the set of workflow instances associated with the set of workflow instance identifiers further includes terminating the set of workflow instances using a workflow web service. A workflow web service is any web service that is accessible from or otherwise associated with a workflow application, such as CA® Workflow. The workflow web service maybe accessible over a network such as network 102 in FIG. 1.

In another embodiment, the process, in response to determining that the set of workflow instances has been deleted or terminated, removes the set of workflow instance identifiers that identify the set of workflow instances from a set of tickets associated with the set of workflow instance identifiers. In another embodiment, the process, in response to terminating the set of workflow instances, terminates the set of tickets associated with the set of workflow instances using the service desk web service.

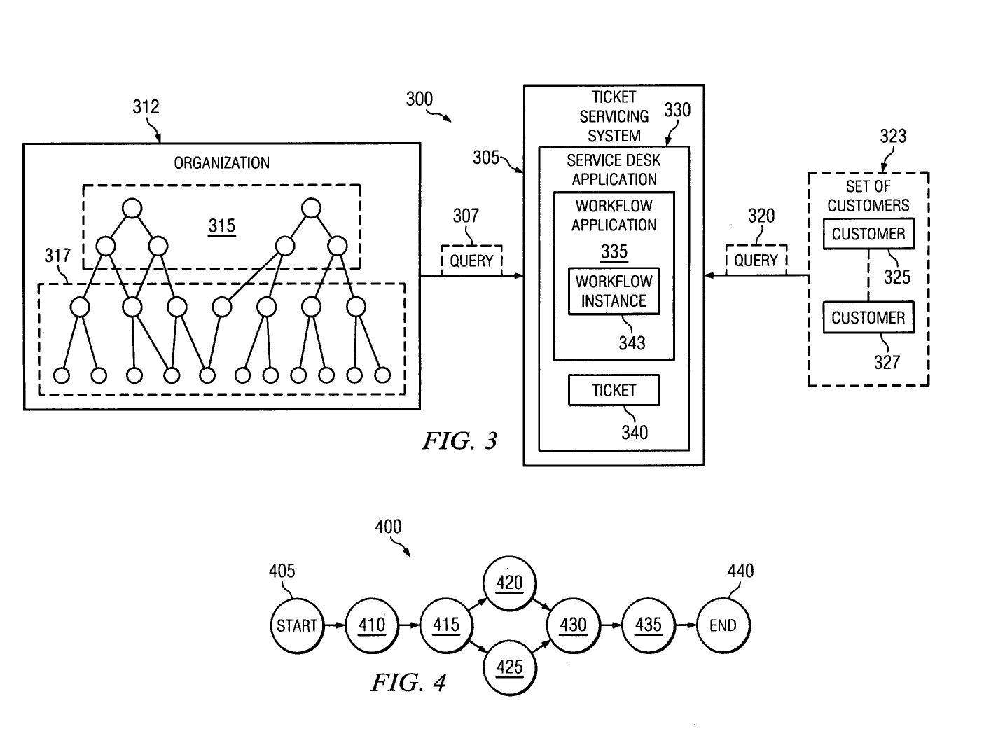

Turning now to FIG. 3, a block diagram of a ticket servicing system is depicted in which the illustrative embodiments may be implemented. Specifically, FIG. 3 shows data processing system 300, which contains components that manage workflow instances for tickets using ticket servicing system 305. Data processing system 300 may be implemented in data processing system 100 in FIG. 1, data processing system 200 in FIG. 2, or any one of servers 104 and 106 and clients 110, 112, and 114 in FIG. 1.

Ticket servicing system 305 receives query 307 from organization 312. Organization 312 may be any entity that includes two or more individuals, such as a corporation, partnership, association, department, governmental agency, or tenants in a common building. In the non-limiting example shown in FIG. 3, organization 312 includes upper tier employees 315 and lower tier employees 317. Upper tier employees 315 include senior employees that rank higher than lower tier employees 317 in organization 312. For example, upper tier employees 315 may include managers and other employees with a supervisory capacity. The lines connecting upper tier employees 315 and lower tier employees 317 to and amongst each other illustrate of the hierarchal structure the employees in organization 312.

Organization 312 may employ a network data processing system, such as network data processing system 100 in FIG. 1. For example, each of upper tier employees 315 and lower tier employees 317 may be clients, such as clients 110, 112, and 114 in FIG. 1, to a server, such as servers 104 and 106 in FIG. 1, within or without organization 312. In addition, each of upper tier employees 315 and lower tier employees 317 may be connected to one another via a network data processing system via respective data processing systems, such as data processing system 200 in FIG. 2. Non-limiting examples of data processing systems that may be employed by upper tier employees 315 and lower tier employees 317 to connect to a network data processing system include desktop computers, laptop computers, and personal digital assistants.

Query 307 from organization 312 may be any issue for which a workflow may be used to address. For example, query 307 may be a request for service to the network data processing system connecting upper tier employees 315 and lower tier employees 317. In this example, query 307 may stem from a malfunction or absence of any component of the network data processing system. Query 307 may also be a request from anyone of upper tier employees 315 and lower tier employees 317 for a change of one or more of the components of the network data processing system. In another example, query 307 may be a request for service to any of the respective data processing systems used by each of upper tier employees 315 and lower tier employees 317, such as a respective employee's desktop computer, laptop computer, or personal digital assistant.

Query 307 to ticket servicing system 305 is not limited to queries of a technical nature. For example, query 307 may relate to a personnel matter, a client matter, a production matter, or any other matter concerning organization 312 for which a workflow maybe used.

Ticket servicing system 305 may also receive query 320 from set of customers 323. Set of customers 323 includes customers 325 and 327. Although set of customers 323 includes two customers 325 and 327, set of customers 323 may include any number of customers.

Any of set of customers 323 may submit query 320 to ticket servicing system 305. Query 320 may pertain to any issue originating from any of set of customers 323 that may be addressed using a workflow. In one example, ticket servicing system 305 is a part of organization 315. In this example, organization 315 may provide technical support to set of customers 323 by receiving technical requests from set of customers 323 and addressing each request using ticket servicing system 305 and the workflows therein.

Each of set of customers 323 may also be clients, such as clients 110, 112, and 114 in FIG. 1, which are connected to one or more servers, such as servers 104 and 106 in FIG. 1, via a network such as network 102 in FIG. 1. The servers may be administered by organization 312. Query 320 from set of customers 323 may pertain to problems and issues regarding the network or the client computing devices being used by set of customers 323 for connection to the network For example, query 320 may be a request for service from any of set of customers 323 that is unable to connect to the network. Query 320 may also be a request for a new computing device or other technical equipment, such as a desktop computer, laptop computer, or personal digital assistant.

Ticket servicing system 305 may be external or internal to organization 312. For example, ticket servicing system 305 may be administered by an entity that is separate from both organization 312 and set of customers 323, and which manages queries and other issues for organization 312 and set of customers 323. In another example, ticket servicing system 305 may be administered by an individual or department of organization 312. In this example, the individual or department administering ticket servicing system 305 may manage queries and other issues that originate from within organization 312, from set of customers 323, or from any other source that could potentially submit queries and issues.

Ticket servicing system 305, which receives queries 307 and 320 from organization 312 and set of customers 323, respectively, includes service desk application 330. Service desk application 330 manages one or more tickets that may correspond to the queries that are submitted to ticket servicing system 305. In one example, service desk application 330 may be Unicenter® Service Desk from CA®, Inc.

Service desk application 330 includes workflow application 335. In one example, workflow application 335 is integrated with service desk application 330, and may used as one of several tools available to service desk application 330. Workflow application 335 manages workflows and executes workflow instances that may be used to address problems and issues, such as the problems and issues associated with queries 307 and 320. In one example, workflow application 335 may be CA® Workflow.

Upon receiving a query, such as queries 307 and 320, service desk application 330 may generate or open a ticket associated with the received query. Ticket 340 maybe generated or opened automatically by service desk application 330 upon receiving the query, or may also be manually opened using service desk application 330.

Upon generating or opening ticket 340 in service desk application 330, workflow application 335 generates or opens workflow instance 343. Workflow instance 343 describes, in a workflow format, a set of activities that address the issues or solves a problem posed by a query from organization 312 or set of customers 323. Additional details regarding the format and structure of a workflow instance is provided in FIG. 4.

Workflow instance 343 may also be modified in workflow application 335. For example, a user that is executing workflow instance 343 may modify workflow instance 343 to better address a query or achieve any other desired objectives. In this example, a user may add or delete activities or steps, change the actors associated with the activities or steps, change the speed at which the activities or steps are performed, or perform any other modifications to workflow instance 343 allowable by workflow application 335. The modification of workflow instance 343 may occur in an Integrated Design Environment of CA® Workflow. In one non-limiting example, the user may be an employee of a department that utilizes ticket servicing system 305 or is otherwise capable of using workflow application 335.

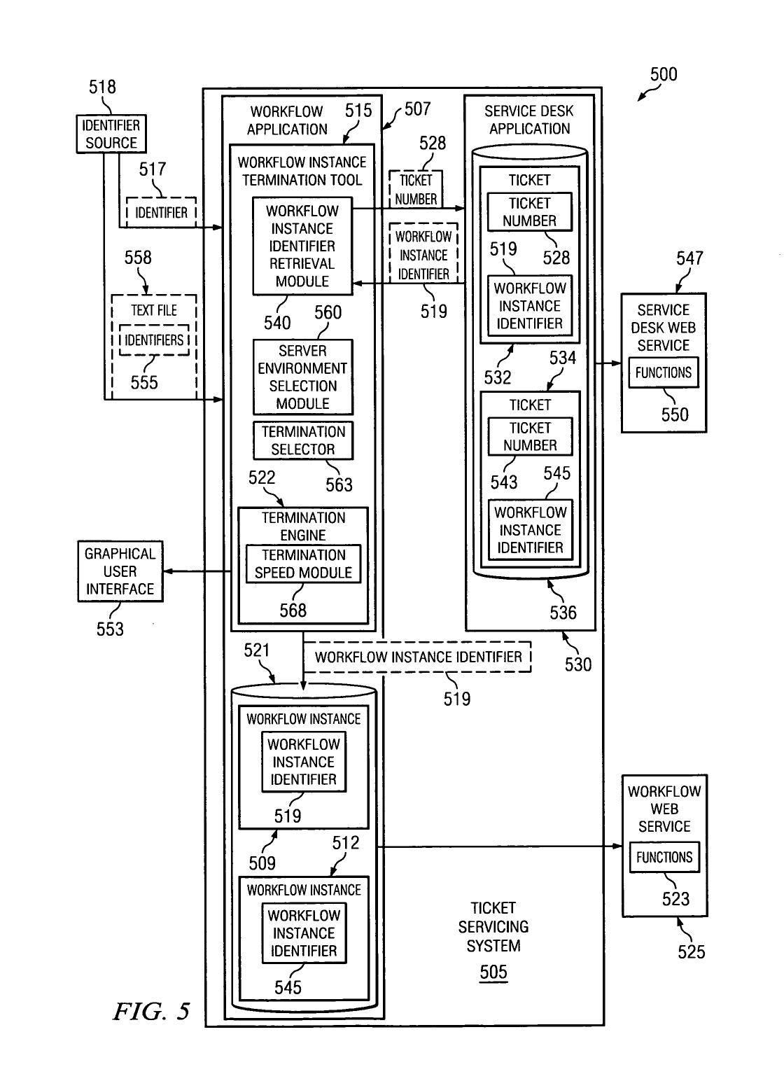

Workflow application 335 also facilitates the termination of executing workflow instances, such as workflow instance 343. Additional details regarding the termination of workflow instances in workflow application 335 will be provided below in FIG. 5.

Turning now to FIG. 4, a diagram of a workflow is depicted with which the illustrative embodiments maybe implemented. Specifically, FIG. 4 shows workflow 400, which is an example of workflow instance 343 in FIG. 3.

Workflow 400 includes start node 405, nodes 410, 415, 420, 425, 430, and 435, and end node 440. Each of the nodes performs one or more activities that facilitate the objective of workflow 400. In addition, one or more actors, such as a human being, machine, or application, may perform each of the activities represented by each of the nodes.

By way of example to illustrate a workflow, the objective of workflow 400 may be to facilitate an equipment change request in response to a request from an employee outside of the IT department to change a piece of equipment, such as a desktop computer. In this example, the activity associated with node 410 may be to send an e-mail to a supervisor in the IT department requesting the supervisor's approval of the desktop computer change request. The activity associated with node 415 may be to decide whether to grant the change request based on the response of the IT supervisor. If the IT supervisor grants the change request, an e-mail maybe sent to the requesting employee notifying the employee of the approval at node 420. On the other hand, if the IT supervisor denies the change request, an e-mail may be sent to the requesting employee notifying the employee of the denial at node 425. Node 430 may then merge the approval and denial routes to continue with the workflow. Node 435 may then change the status of the change request to reflect whether the change request was approved or denied.

Workflow 400 may also be edited using a workflow application, such as workflow application 335 in FIG. 3. For example, in the case in which workflow 400 is a workflow in CA® Workflow, start node 405, nodes 410, 415, 420, 425, 430, and 435, and end node 440 may be deleted, moved, or otherwise modified in an Integrated Design Environment. Additional nodes may also be added to workflow 400. The flow of workflow 400, as indicated by the lines connecting the nodes, may also be modified using the Integrated Design Environment of CA® Workflow.

Turning now to FIG. 5, a diagram of a ticket servicing system for terminating workflow instances in a workflow application is depicted in accordance with an illustrative embodiment. Specifically, FIG. 5 shows data processing system 500, which contains components for terminating workflow instances in a workflow application. Data processing system 500 may be implemented in data processing system 100 in FIG. 1, data processing system 200 in FIG. 2, or anyone of servers 104 and 106 and clients 110, 112, and 114 in FIG. 1.

Data processing system 500 includes ticket servicing system 505. Ticket servicing system 505 is a non-limiting example of ticket servicing system 305 in FIG. 3. Ticket servicing system 505 includes workflow application 507. Workflow application 507 is a non-limiting example of workflow application 335 in FIG. 3. In one example, workflow application 507 is CA® Workflow.

As described above in FIG. 3, a workflow application, such as workflow application 507, may have one or more executing workflow instances that are associated with one or more tickets. In FIG. 5, workflow application 507 includes workflow instances 509 and 512. Workflow instance termination tool 515 in workflow application 507 facilitates the termination of workflow instances 509 and 512. In one embodiment, workflow instance termination tool 515 creates a background thread and may execute on that background thread. Also, although workflow application 507 is shown to have two workflow instances 509 and 512, workflow application 507 may have any number of workflow instances, any of which may be terminated using workflow instance termination tool 515.

Workflow instance termination tool 515 receives identifier 517 from identifier source 518. Identifier source 518 may be any individual, entity, or process capable of sending an identifier, such as identifier 517. For example, identifier source 518 may be any user or computer process or application.

In one embodiment, identifier 517 is workflow instance identifier 519, which identifies workflow instance 509 in workflow application 507. In this embodiment, identifier 517, which is workflow instance identifier 519, matches workflow instance identifier 519 of workflow instance 509 in database 521. Termination engine 522 may terminate workflow instance 509 using functions 523 that are accessed using workflow web service 525. Termination engine 522 may also log into workflow web service 525 as part of the process of accessing functions 523. Functions 523 may be accessible though an application programming interface used by workflow application 507. In one example, workflow web service 525 maybe a web service accessible specifically by CA® Workflow.

In another embodiment, identifier 517 is ticket number 528. In this embodiment, workflow instance retrieval module 540 identifies the workflow instance identifier associated with ticket number 528. For example, workflow instance retrieval module 540 may retrieve the workflow instance identifier associated with ticket number 528 from service desk application 530.

In the example shown in FIG. 5, workflow instance identifier module 540 accesses database 536 of service desk application 530. Database 536 includes tickets 532 and 534, which may also be records in database 536. Tickets 532 and 534 are managed by service desk application 530. Each ticket 532 and 534 includes data about the ticket, such as the ticket number for the ticket and the workflow instance identifiers for each workflow instance associated with the ticket. In particular, ticket 532 includes ticket number 528 and workflow instance identifier 519, and ticket 534 includes ticket number 543 and workflow instance identifier 545. Also, although database 526 includes two tickets 532 and 534, database 536 may include any number of tickets. In the embodiment in which service desk application 530 is Unicenter® Service Desk tickets 532 and 534 maybe Unicenter® Service Desk tickets.

Workflow instance identifier module 540 identifies one or more tickets in database 536 that include ticket number 528. In particular, workflow instance identifier module 540 identifies ticket 532 as including ticket number 528. Workflow instance identifier module 540 then retrieves workflow instance identifier 519 from ticket 532.

Workflow instance identifier retrieval module 540 may also retrieve workflow instance identifier 519, which is associated with ticket number 528, from service desk application 530 using service desk web service 547. For example, workflow instance identifier retrieval module 540 may retrieve workflow instance identifier 519 using functions 550 that are accessed using service desk web service 547. Workflow instance identifier retrieval module 540 may also log into service desk web service 547 as part of the process of accessing functions 550. Functions 550 may be accessible though an application programming interface used by workflow application 507. In one example, service desk web service 547 may be Unicenter® Service Desk web service, which is accessible using either CAM Workflow or Unicenter® Service Desk.

Upon the retrieval of workflow instance identifier 519 by workflow instance identifier retrieval module 540, termination engine 522 may then terminate workflow instance 509, which is identified by workflow instance identifier 519. For example, termination engine 522 may terminate workflow instance 509 in the manner described above in the embodiment in which identifier 517 is a workflow instance identifier.

In one embodiment, termination engine 522 may determine whether workflow instance 509 has been deleted or terminated. Workflow instance 509 may have been deleted from workflow application 507 for a variety of reasons. For example, workflow instance 509 may have been corrupted or otherwise impaired and thereafter purged from workflow application 507. In this example, such purges may occur on a nightly basis to erase impaired workflow instances. In response to determining that workflow instance 509 has been deleted, termination engine 522 may remove workflow instance identifier 519 from the ticket corresponding to ticket 532. In one example, termination engine 522 may erase workflow instance identifier 519 from a field in ticket 532. In another example, service desk web service 547 may be used to set the field containing workflow instance identifier 519 in ticket 532 to null.

In another embodiment, in response to terminating workflow instance 509, termination engine 522 may terminate ticket 532, which is associated with workflow instance 509. In this embodiment, termination engine 522 may terminate ticket 532 using functions 550 of service desk web service 547. Thus, a user does not have to separately search for and terminate ticket 532 in service desk application 530, and may instead close ticket 532 using workflow instance termination tool 515 upon closing workflow instance 509.

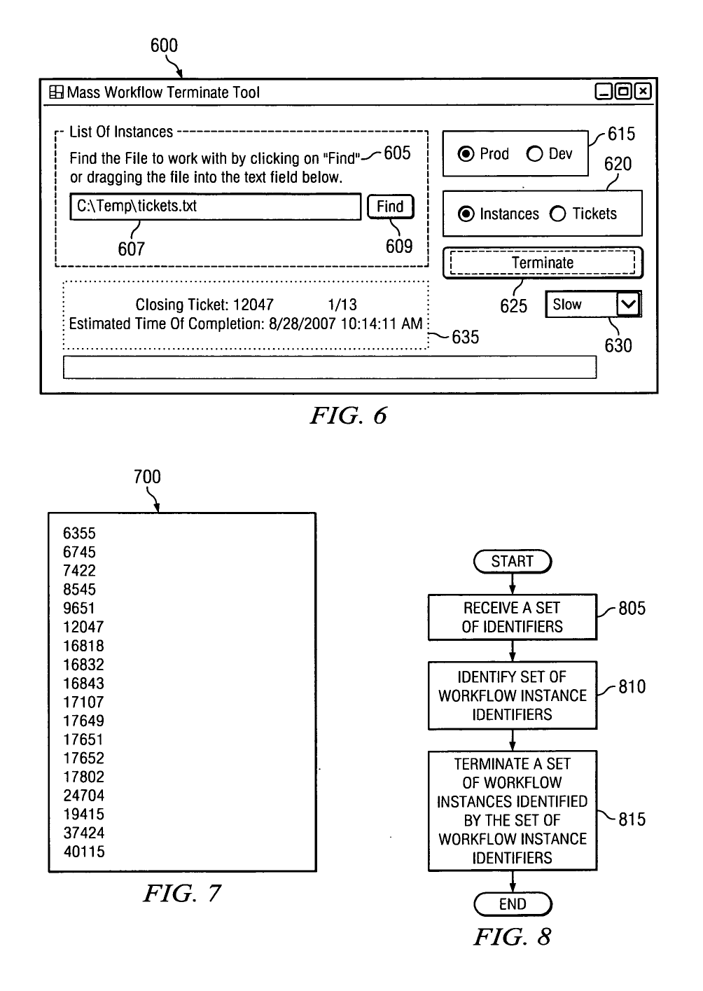

In another embodiment, in response to terminating workflow instance 509, workflow instance termination tool 515 may display a status on graphical user interface 553. Graphical user interface is a non-limiting example of display 214 in FIG. 2. In one example, graphical user interface may notify a user when workflow instance 509, ticket 532, or both have been terminated. Graphical user interface may also notify a user if an error has occurred, such as when workflow instance 509 has been purged from workflow application 507. Additional details regarding the display of a status to a user will be provided below and with respect to FIG. 6.

In the illustrative embodiments described above, only one identifier 517, such as a workflow instance identifier or a ticket number, has been received by workflow application 507. However, workflow application may receive any number of identifiers and terminate the workflow instances and tickets associated with those identifiers in a batch process. Thus, time and resources may be saved by avoiding the need to close or terminate each workflow instance and ticket individually.

For example, one or more identifiers may be included in text file 558 and submitted to workflow application 507 from identifier source 518. Although FIG. 5 shows identifiers 555 in a text file, other types of files may also include identifiers 555, such as Microsoft® Word files, WordPerfect files, Notepad files, and any other type of file or list capable of including at least one identifier. Such files may have any file extension, including but not limited to .doc, .txt, .rtf, or .wpd. Identifiers 555 may also be included in a data stream being transmitted over a network, such as network 102 in FIG. 1.

In one embodiment, each of identifiers 555 is a workflow instance identifier, such as workflow instance identifiers 519 and 545, which identifies a workflow instance in workflow application 507, such as workflow instances 509 and 512. In this embodiment, termination engine 522 may terminate each workflow instance identified by each of the workflow instance identifiers in text file 558. Each workflow instance identified by the workflow instance identifiers in text file 558 may be terminated by termination engine 522 in the same or similar manner described above with respect to the illustrative embodiments. Termination engine 522 may also terminate each ticket associated with the terminated workflow instances in the same or similar manner described above with respect to the illustrative embodiments.

In another embodiment, each of identifiers 555 is a ticket number, such as ticket numbers 528 and 543, which identify tickets 532 and 534 that are associated with workflow instances 509 and 512. In this embodiment, workflow instance identifier retrieval module 540 may identify a set of workflow instance identifiers that are associated with each ticket number in text file 558 in the same or similar manner described above with respect to the illustrative embodiments. In a non-limiting example in which text file 558 includes ticket numbers 528 and 543, workflow instance identifier retrieval module 540 may retrieve workflow instance identifiers 519 and 545 from service desk application 530. Termination engine 522 may then terminate workflow instances 509 and 512, which are identified by workflow instance identifiers 519 and 545, in the same or similar manner described above with respect to the illustrative embodiments. In conjunction with the termination of workflow instances 509 and 512, termination engine 522 may also terminate tickets 532 and 534 in the same or similar manner described above with respect to the illustrative embodiments.

Workflow instance termination tool 515 includes server environment selection module 560. Server environment selection module 560 determines a server environment in which to execute workflow instance termination tool 515. For example, workflow instance termination tool 515 may run in a production server environment or a development server environment. The production server environment is the software and hardware used by the end users of ticket servicing system 505. In the development server environment, workflow instance termination tool 515 maybe tested and otherwise utilized by users that are developing workflow instance termination tool 515. For example, the development server environment may be the software and hardware used by a set of developers to create and test changes to ticket servicing system 505 before the changes are migrated to the production environment for use by the end users. In addition, server environment selection module 560 allows for the selection of any combination of production or development environments in which to execute workflow instance termination tool 515. For example, a company using ticket servicing system 505 may have several production instances of ticket servicing system 505 that handles regional traffic. In this case, server environment selection module 560 could be pointed at a specific production instance of the software to provide the functionality for ticket servicing system 505 in that region. As described in further detail below in FIG. 6, the server environment in which to execute workflow instance termination tool 515 may be based on a user selection.

Workflow instance termination tool 515 includes termination selector 563. Termination selector 563 determines whether to terminate either or both of the workflow instances or tickets that are associated with identifiers 555. For example, in the case in which identifier 517 or identifiers 555 includes workflow instance identifier 519 or ticket number 528, termination selector 563 determines whether termination engine 522 will terminate either or both of workflow instance 509 or ticket 532. As will be discussed in greater detail in FIG. 6, the determination as whether to terminate either or both of workflow instance identifier 519 or ticket number 528 maybe based on a user selection.

Termination engine 522 includes termination speed module 568. Termination speed module 568 determines a speed at which to terminate the workflow instances or tickets identified by the identifiers 555. For example, termination speed module may have different degrees at which to terminate the workflow instances or tickets identified by the identifiers 555, such as “slow,” “medium,” and “fast.” Each of these speed settings may have an associated amount of time that determines how long to wait between the termination of each of the workflow instances or tickets, such as one second, one minute, five minutes, or any other amount of time. Also, as illustrated in further detail in FIG. 6, the speed at which to terminate the workflow instances or tickets identified by the identifiers 555 may be based on a user selection. Alternatively, a reporting or feedback function (not shown) maybe utilized to notify workflow instance termination tool 515 that one workflow instance is terminated and to initiate terminating the next workflow instance.

Turning now to FIG. 6, a graphical representation of a mass workflow terminate tool for terminating workflow instances in a workflow application is depicted in accordance with an illustrative embodiment. Specifically, FIG. 6 shows mass workflow terminate tool 600. Mass workflow terminate tool 600 is a graphical representation that may be displayed on a graphical user interface, such display 214 in FIG. 2 and graphical user interface 553 in FIG. 5.

Mass workflow terminate tool 600 provides a graphical representation of one or more features of a ticket servicing system, such as ticket servicing system 305 in FIG. 3 and ticket servicing system 505 in FIG. 5. For example, mass workflow terminate tool 600 may display one or more of the features of a workflow instance termination tool, such as workflow instance termination tool 515.

Mass workflow terminate tool 600 includes a list of instances section 605. List of instances section 605 includes field 607 in which a name or path of a file may be inserted. In particular, the name of a file that includes identifiers, such as identifiers 555 in FIG. 5, may be inserted into field 607. Either or both of the workflow instances or tickets corresponding to the identifiers that are included in the file in field 607 may then be terminated by a workflow application, such as workflow application 507 in FIG. 5, in accordance with the illustrative embodiments. Find button 609 may be used in order to facilitate searching for the file to be inserted in field 607. For example, find button 609 may launch a dialog box that allows a user to search in a file folder system for the appropriate file. Although FIG. 6 depicts field 607 as including a text file path, the file name or path of any file type capable of including an identifier maybe inserted into field 607.

Mass workflow terminate tool 600 includes server environment section 615. Server environment section 615 allows a user to select the server environment used by a server environment selection module, such as server environment selection module 560 in FIG. 5, which, in turn, determines the server environment that will be used by a workflow instance termination tool, such as workflow instance termination tool 515 in FIG. 5. In particular, server environment section 615 includes a “Prod” radio button, which allows a user to select a production server environment, and a “Dev” radio button, which allows a user to select a development server environment. Other server environments, such as a particular production server environment of several existing production server environments, may also be selected by a user by adding additional options to server environment section 615.

Mass workflow terminate tool 600 may include termination selector 620. Termination selector 620 allows a user to select whether to terminate workflow instances, tickets, or a combination thereof based on the identifiers in the file in field 607. For example, by selecting the “Instances” radio button, workflow instances that are associated with the identifiers in the file in field 607 will be terminated by a termination engine, such as termination engine 522, in accordance with the illustrative embodiments. By selecting the “Tickets” radio button, tickets that are associated with the identifiers in the file in field 607 will be terminated by a termination engine, such as termination engine 522, in accordance with the illustrative embodiments. Both the “Instances” and “Tickets” radio button may also be selected in order to terminate both workflow instances and tickets.

Mass workflow terminate tool 600 includes terminate button 625. Terminate button 625 initiates the termination of either or both of workflow instances or tickets depending on the option selected in termination selector 620. For example, terminate button 625 may initiate a termination process by a termination engine, such as termination engine 522, to terminate either or both of workflow instances or tickets in accordance with the illustrative embodiments.

Mass workflow terminate tool 600 includes termination speed drop down box 630. Termination speed drop down box 630 allows a user to select a termination speed for a termination speed module, such as termination speed module 568 in FIG. 5.

Mass workflow terminate tool 600 includes status portion 635. Status portion 635 displays a status of the workflow instance or ticket termination process. For example, status portion 635 indicates the ticket number of the ticket that is currently being closed by a workflow instance termination tool. The characters “ 1/13” indicate that the first of thirteen tickets is currently being terminated. In one example, the ticket numbers for the thirteen tickets may have been included in a text file, such as text file 558 in FIG. 5. Status portion 635 also indicates the estimated time to complete terminating all or a portion of the workflow instances or tickets that are to be terminated. Status portion 635 may also indicate other data about the termination process. For example, status portion 635 may include a count of successful terminations, a count of deleted instances, a count of successfully closed tickets, elapsed time, return codes for the last request, or any other data relating to the termination process.

Turning now to FIG. 7, a graphical representation of a text file containing identifiers for terminating workflow instances in a workflow application is depicted in accordance with an illustrative embodiment. Specifically, FIG. 7 shows text file 700, which is a non-limiting example of text file 558 in FIG. 5.

Text file 700 may include one or more ticket numbers. In another illustrative example, text file 700 may also include one or more workflow instance identifiers, as well as a combination of both ticket numbers and workflow instance identifiers. Text file 700 may be submitted to a workflow instance termination tool, such as workflow instance termination tool 515 in FIG. 5. The workflow instances or tickets associated with the ticket numbers or workflow instance identifiers contained in text file 508 may then be terminated by a termination engine, such as termination engine 522 in FIG. 5, in accordance with the illustrative embodiments. Also, although FIG. 7 shows text file 700, the ticket numbers or workflow instance identifiers contained therein maybe included in any type of file capable of including such identifiers.

Turning now to FIG. 8, a flowchart illustrating a process for terminating workflow instances in a workflow application is depicted in accordance with an illustrative embodiment. The process illustrated in FIG. 8 maybe implemented by a workflow instance termination tool, such as workflow instance termination tool 515 in FIG. 5.

The process receives a set of identifiers (step 805). For example, the set of identifiers may be a set of workflow instance identifiers, a set of ticket numbers, or a combination thereof. The set of identifiers may also be included in a file, such as a text file. The process identifies a set of workflow instance identifiers associated with the set of identifiers (step 810). The process terminates a set of workflow instances identified by the set of workflow instance identifiers (step 815). The process then terminates.

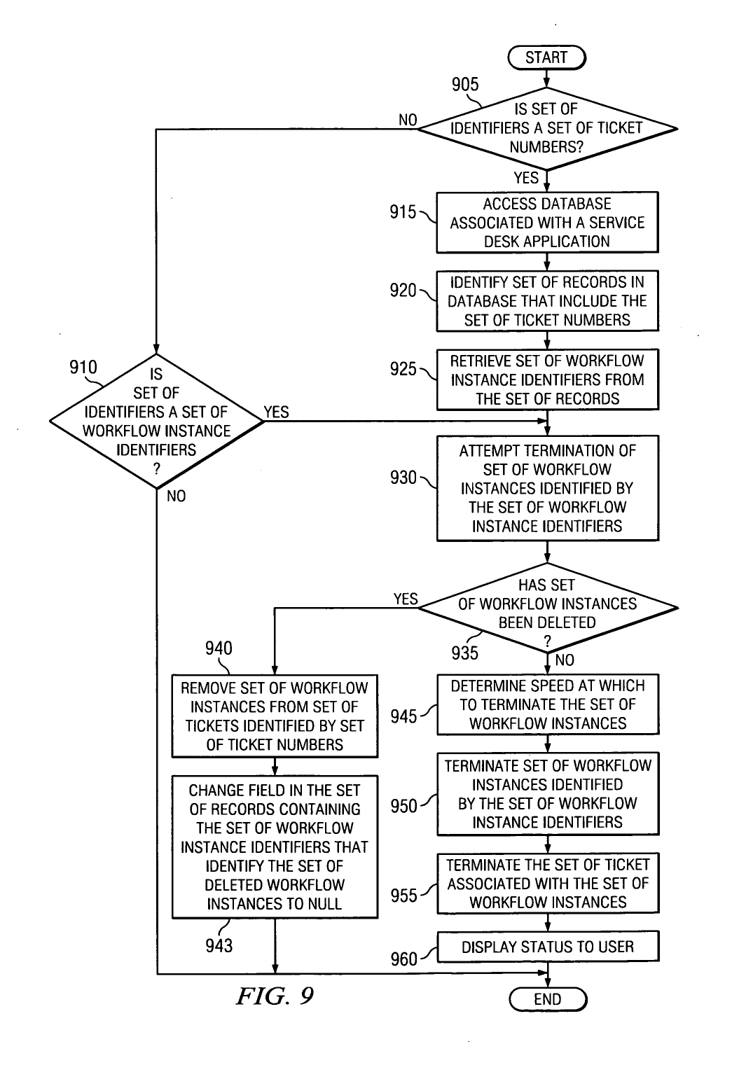

Turning now to FIG. 9, a flowchart illustrating a process for terminating workflow instances in a workflow application in accordance with an illustrative embodiment. The process illustrated in FIG. 9 may be implemented by a workflow instance termination tool, such as workflow instance termination tool 515 in FIG. 5. The process illustrated in FIG. 9 also illustrates additional embodiments of steps 805, 810, and 815 in FIG. 8.

The process determines whether the set of identifiers is a set of ticket numbers (step 905). If the process determines that the set of identifiers is not a set of ticket numbers, the process determines whether the set of identifiers is a set of workflow instance identifiers (step 910). If the process determines that the set of identifiers is a set of workflow instance identifiers, the process proceeds to step 930. If the process determines that the set of identifiers is not a set of workflow instance identifiers, the process then terminates.

Returning to step 905, if the process determines that the set of identifiers is a set of ticket numbers, the process accesses a database associated with a service desk application (step 915). The process identifies a set of records in the database that includes the set of ticket numbers (step 920). The process retrieves the set of the workflow instance identifiers from the set of records (step 925). The process attempts to terminate the set of workflow instances identified by the set of workflow instance identifiers (step 930).

The process determines whether the set of workflow instances has been deleted, such as whether the set of workflow instances have been purged due to impairment of the workflow instances (step 935). If the process determines that the set of workflow instances has been deleted, the process removes the set of workflow instances from the set of tickets identified by the set of ticket numbers (step 940). In one example, the process also changes the field in the set of records containing the set of workflow instance identifiers that identify the set of deleted workflow instances to null (step 943). The process then terminates.

Returning to step 935, if the process determines that the set of workflow instances has not been deleted, the process may determine a speed at which to terminate the set of workflow instances (step 945). In one example, the process may also determine a speed at which to terminate a set of tickets associated with the set of workflow instances. The process terminates the set of workflow instances identified by the set of workflow instance identifiers (step 950). The process may also then terminate the set of tickets associated with the set of workflow instances (step 955). The process displays a status of the termination process to a user (step 960). The process then terminates.

The flowcharts and block diagrams in the different depicted embodiments illustrate the architecture, functionality, and operation of some possible implementations of apparatus, methods and computer program products. In this regard, each block in the flowchart or block diagrams may represent a module, segment, or portion of code, which comprises one or more executable instructions for implementing the specified function or functions. In some alternative implementations, the function or functions noted in the block may occur out of the order noted in the figures. For example, in some cases, two blocks shown in succession may be executed substantially concurrently, or the blocks may sometimes be executed in the reverse order, depending upon the functionality involved.

The illustrative embodiments described herein provide a computer-implemented method, apparatus, and computer program product for terminating workflow instances in a workflow application. In one embodiment, the workflow application is Workflow from CA®, Inc.

The process receives a set of identifiers. The process identifies a set of workflow instance identifiers associated with the set of identifiers.

In one embodiment, receiving the set of identifiers further includes receiving the set of workflow instance identifiers. In this embodiment, receiving the set of workflow instance identifiers may also include receiving a text file including the set of workflow instance identifiers.

In another embodiment, receiving the set of identifiers further includes receiving a set of ticket numbers associated with a set of tickets. A ticket may be a Unicenter® Service Desk ticket. In another embodiment, receiving the set of ticket numbers further includes receiving a text file including the set of ticket numbers. The set of ticket numbers may also be included in other types of files capable of including at least one ticket number.

Also, in this embodiment, identifying the set of workflow instance identifiers associated with the set of identifiers may include retrieving the set of workflow instance identifiers associated with the set of tickets from a service desk application, such as Unicenter® Service Desk using a service desk web service. The set of workflow instance identifiers may be retrieved using any web service, including Unicenter® Service Desk web service.

In one example, retrieving the set of workflow instance identifiers associated with the set of tickets from the service desk web service may include accessing a database associated with the service desk web service. In this example, the process may also identify a set of records in the database that include the set of ticket numbers. Also in this example, the process may retrieve the set of workflow instance identifiers from the set of records.

In one embodiment, the process terminates a set of workflow instances identified by the set of workflow instance identifiers. A workflow instance is an executing workflow in a workflow application, such as CA® Workflow.

In one embodiment, terminating the set of workflow instances associated with the set of workflow instance identifiers further includes terminating the set of workflow instances using a workflow web service. A workflow web service is any web service that is accessible from or otherwise associated with a workflow application, such as CA® Workflow.

In another embodiment, the process, in response to determining that the set of workflow instances has been deleted, removes the set of workflow instance identifiers that identify the set of workflow instances from a set of tickets associated with the set of workflow instance identifiers. In another embodiment, the process, in response to terminating the set of workflow instances, terminates the set of tickets associated with the set of workflow instances using the service desk web service.

The illustrative embodiments described herein allow a user to terminate a workflow instance by entering a workflow instance identifier into a software program The illustrative embodiments may receive the workflow instance identifiers via a text file, and then terminate each associated workflow.

The illustrative embodiments also search for a workflow instance identifier in a service desk application, such Unicenter® Service Desk using a ticket number. Currently, even though Unicenter® Service Desk may manage the tickets that are associated with the executing workflow instances, the service desk application may show only a date and time at which a workflow instance has been initiated, but may not show the workflow instance identifiers that identify the currently executing workflow instances. The illustrative embodiments, however, can identify the workflow instance identifier upon receipt of a ticket number using a database in the service desk application.

The illustrative embodiments also close tickets that are attached to a workflow instance to be terminated, thereby saving the time and effort of having to search for and terminate the ticket separate through a service desk application, such as Unicenter® Service Desk.

The principles of the present invention can take the form of an entirely hardware embodiment, an entirely software embodiment or an embodiment containing both hardware and software elements. In one embodiment, the invention is implemented in software, which includes but is not limited to firmware, resident software, microcode, and other computer readable code.

Furthermore, the principles of the present invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory, a read-only memory (ROM), a rigid magnetic disk and an optical disk. Current examples of optical disks include compact disk-read only memory (CD-ROM, compact disk-read/write (CD-R/W) and DVD.

Further, a computer storage medium may contain or store a computer readable program code such that when the computer readable program code is executed on a computer, the execution of this computer readable program code causes the computer to transmit another computer readable program code over a communications link This communications link may use a medium that is, for example without limitation, physical or wireless.

A data processing system suitable for storing and/or executing program code may include at least one processor coupled directly or indirectly to memory elements through a system bus. The memory elements can include local memory employed during actual execution of the program code, bulk storage, and cache memories, which provide temporary storage of at least some program code in order to reduce the number of times code must be retrieved from bulk storage during execution.

Input/output or I/O devices (including but not limited to keyboards, displays, or pointing devices) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed:

1. A method for terminating workflow instances in a workflow application, said method comprising:
receiving a set of identifiers;
identifying a set of workflow instance identifiers associated with the set of identifiers; and
terminating a set of workflow instances identified by the set of workflow instance identifiers.

2. The method according to claim 1, wherein receiving the set of identifiers further includes receiving a set of ticket numbers associated with a set of tickets.

3. The method according to claim 2, wherein identifying the set of workflow instance identifiers associated with the set of identifiers further includes retrieving the set of workflow instance identifiers associated with the set of tickets from a service desk application using a service desk web service.

4. The method according to claim 3, wherein retrieving the set of workflow instance identifiers associated with the set of tickets from the service desk application using the service desk web service further includes:
accessing a database associated with the service desk application;
identifying a set of records in the database that include the set of ticket numbers; and
retrieving the set of workflow instance identifiers from the set of records.

5. The method according to claim 4, wherein receiving the set of tickets includes receiving a set of Unicenter® Service Desk tickets, wherein the service desk application is Unicenter® Service Desk, and wherein the service desk web service is a Unicenter® Service Desk web service.

6. The method according to claim 2, wherein receiving the set of ticket numbers further includes receiving a text file including the set of ticket numbers.

7. The method according to claim 1, wherein terminating the set of workflow instances associated with the set of workflow instance identifiers further includes terminating the set of workflow instances using a workflow web service.

8. The method according to claim 1, further comprising, in response to determining that the set of workflow instances has been deleted, removing the set of workflow instance identifiers that identify the set of workflow instances from a set of tickets associated with the set of workflow instance identifiers.

9. The method according to claim 1, wherein receiving the set of identifiers further includes receiving the set of workflow instance identifiers.

10. The method according to claim 9, wherein receiving the set of workflow instance identifiers further includes receiving a text file including the set of workflow instance identifiers.

11. The method according to claim 1, further comprising, in response to terminating the set of workflow instances, displaying a status of termination to a user using a graphical user interface.

12. The method according to claim 1, wherein terminating the set of workflow instances further includes determining a speed at which to terminate the set of workflow instances.

13. The method according to claim 1, wherein the workflow application is Workflow from CA®, Inc.

14. The method according to claim 1, further comprising, in response to terminating the set of workflow instances, terminating a set of tickets associated with the set of workflow instances using a service desk web service.

15. A system for terminating workflow instances in a workflow application, said system comprising:
a workflow application, the workflow application receiving a set of identifiers;
a workflow instance identifier retrieval module, the workflow instance identifier retrieval module identifying a set of workflow instance identifiers associated with the set of identifiers; and
a termination engine, the termination engine terminating a set of workflow instances identified by the set of workflow instance identifiers.

16. The system according to claim 15, wherein the set of identifiers is a set of workflow instance identifers.

17. The system according to claim 15, wherein the set of identifiers is a set of ticket numbers.

18. The system according to claim 15, wherein the termination engine, in response to terminating the set of workflow instances, terminates a set of tickets associated with the set of workflow instances using a service desk web service.

19. A data processing system comprising:
a bus system;
a memory connected to the bus system, wherein the memory includes a set of instructions; and
a processing unit connected to the bus system, wherein the processing unit executes the set of instructions to receive a set of identifiers; identify a set of workflow instance identifiers associated with the set of identifiers; and terminate a set of workflow instances identified by the set of workflow instance identifiers.

20. The data processing system of claim 19, wherein the processing unit further executes the set of instructions to terminate a set of tickets associated with the set of workflow instances using a service desk web service in response to terminating the set of workflow instances.
